(19) United States
(12) Patent Application Publication
(10) Pub. No.: US 2024/0027573 A1
(43) Pub. Date: Jan. 25, 2024

(54) RF DATA LINK FOR A DEVICE WITH A ROTATING COMPONENT

(71) Applicant: Ouster, Inc., San Francisco, CA (US)

(72) Inventors: Jung Bae Sohn, Redwood City, CA (US); William Treichler, El Cerrito, CA (US); Karthik Kalyanaraman, San Francisco, CA (US)

(73) Assignee: Ouster, Inc., San Francisco, CA (US)

(21) Appl. No.: 18/357,663

(22) Filed: Jul. 24, 2023

Related U.S. Application Data
(60) Provisional application No. 63/369,350, filed on Jul. 25, 2022.

(51) Int. Cl. G01S 7/02; G01S 13/86; G01S 7/282; H01Q 1/22

(52) U.S. Cl. CPC G01S 7/027; G01S 13/865; G01S 7/282; H01Q 1/2283

(57) ABSTRACT

A radio-frequency (RF) data link can be provided between a stationary base component and a rotating component that rotates about an axis defined by a shaft that has a waveguide core (e.g., a hollow core). The rotating component can include a data source such as one or more sensors. An RF transmitter unit can be disposed in the rotating component and can have a first antenna oriented to transmit into one end of the waveguide core of the shaft. The base component can include an RF receiver unit that can have a second antenna located at the other end of the shaft and oriented to receive RE signals through the waveguide core of the shaft. The waveguide core of the shaft can provide a waveguide for RF data transmissions (e.g., in the millimeter-wave band) between the first antenna and the second antenna.

### CROSS-REFERENCE TO RELATED APPLICATION

This application claims the benefit of U.S. Provisional Patent Application No. 63/369,350, filed Jul. 25, 2022, which is incorporated herein by reference.

### BACKGROUND

This disclosure relates generally to electronic devices, such as lidar systems, having a rotating component mounted on a stationary base and in particular to a radio frequency (RF) data link between the rotating component and the stationary base.

Time of flight (ToF) based imaging is used in a number of applications, including range finding; depth profiling; and 3D imaging, such as light imaging, detection, and ranging (LiDAR, or lidar). Direct time of flight (dToF) measurement includes directly measuring the length of time between emitting radiation from emitter element(s) and sensing the radiation by detector element(s) after reflection from an object or other target. The distance to the target can be determined from the measured length of time. Indirect time of flight measurement includes determining the distance to the target by phase modulating the amplitude of the signals emitted by the emitter element(s) of the lidar system and measuring phases (e.g., with respect to delay or shift) of the echo signals received at the detector element(s) of the lidar system. These phases may be measured with a series of separate measurements or samples. A typical lidar system includes an array of emitter elements and a corresponding array of detector elements. The emitter and detector elements can be arranged to concurrently sample depth information at different locations in a field of view.

To provide a 360-degree field of view, some lidar systems including a rotating component that houses the emitters and detectors. The rotating component is coupled to a stationary base that includes a motor to spin the rotating component at a desired speed. The stationary base generally also includes a data interface to deliver detector data from the lidar system to other systems.

Prior to delivering data to external systems, the data must be transmitted from the rotating component to the stationary base. Depending on implementation, the rotating component can generate a large volume of data (e.g., on the order of gigabits per second). For some applications, real-time data transfer is desirable.

### SUMMARY

Transferring data at high rates between a rotating component and a stationary (or base) component has proven challenging. Fixed wires provide high data rates; however, having wires connected between moving parts can create reliability issues, and where the rotating component rotates continuously in one direction, fixed wires are not a viable option. Some lidar systems use a slip-ring interface that includes a metal contact (such as a brush) that rubs against a rotating ring, which in some instances can be a liquid mercury ring, providing a conductive transfer. Slip-ring constructions, however, tend to be bulky, and the use of mercury raises environmental concerns. Some lidar systems use an optical interface. For example, a shaft around which the rotating component spins can be a hollow shaft. An optical transmitter, such as one or more LEDs, can be placed on the rotating component at one end of the shaft while an optical receiver is placed on the stationary component at the other end of the shaft. Light pulses from the transmitter can travel down the shaft and be detected by the optical receiver, enabling communications. However, optical communication might not provide sufficient data bandwidth for some applications. In addition, due to the physics of existing optical devices, optical communication may require careful temperature compensation. Accordingly, improved communication links may be desirable.

Certain aspects of this disclosure relate to radio frequency (RF) data links providing for data transmission between a rotating component and a stationary component of a system such as a lidar system. In some embodiments, a radio-frequency (RF) data link can be provided between a first component (e.g., a stationary base) and a second component that rotates about an axis defined by a shaft that has a waveguide core. The waveguide core can include a hollow region through the shaft with inner sidewalls that reflect RF electromagnetic waves at frequencies of interest (e.g., in the carrier band of the data link). Alternatively, the waveguide core can be filled with a material or medium that is transparent to RF electromagnetic waves at frequencies of interest; sidewalls of the core can be reflective at such frequencies. The second component (and/or the first component) can include a data source such as one or more sensors. An (RF) transmitter unit can be disposed in the second component and can have a first antenna oriented to transmit into one end of the waveguide core of the shaft. The first component can include an RF receiver unit that can have a second antenna located at the other end of the shaft and oriented to receive RF signals through the waveguide core of the shaft. The waveguide core of the shaft can provide a waveguide for RF data transmissions (e.g., in the millimeter-wave band) between the first antenna and the second antenna. In various embodiments, the first antenna can be optimized to transmit circularly polarized waves, and the second antenna can be optimized for signal coupling strength.

According to some embodiments of the present invention, a system can include: a first component (such as a stationary base); a shaft extending from a surface of the first component, the shaft defining an axis of rotation and having a waveguide core; a second component mounted to the shaft and rotatable about the axis of rotation; a radio-frequency (RF) transmitter unit disposed in the second component, the RF transmitter unit including a first antenna positioned at a first end of the shaft and oriented to transmit into the waveguide core of the shaft; and an RF receiver unit disposed in the first component, the RF receiver unit including a second antenna positioned at a second end of the shaft and oriented to receive RF signals through the waveguide core of the shaft. The waveguide core of the shaft can provide a waveguide for RF data transmissions between the first antenna and the second antenna. In some embodiments, the RF data transmissions can be in a millimeter-wave band (e.g., with a carrier frequency of approximately 60 GHz). In some embodiments, the first antenna can be configured, e.g., by size and shape, to produce circularly polarized RF waves, which can improve uniformity of signal strength as the second component (including the first antenna) rotates about the axis of rotation. In some embodiments, each of the first antenna and the second antenna can be a patch antenna constructed on a substrate comprising a low-loss copper clad laminate, with a metallic antenna shape printed on a surface of the substrate. In some embodiments, the waveguide core of the shaft can have a circular cross section and a diameter selected to reduce propagation of unwanted electromagnetic modes. The RF data link between the RF transmitter unit and the RF receiver unit can be used to communicate any type of data, including but not limited to data from sensors (such as a lidar sensor array) disposed in the second component.

In some embodiments, the RF transmitter unit and RF receiver unit can provide a high-speed data link in one direction (referred to herein as a “downlink”), while data transmission in the other direction (referred to herein as an “uplink”) is provided using other technologies. For instance, an optical transmitter unit can be mounted to the base and optically coupled to the waveguide core of the shaft, and an optical receiver unit can be mounted to the rotating component and optically coupled to the waveguide core of the shaft.

According to some embodiments of the invention, a bidirectional RF data link can be provided. For example, some embodiments of a system can include: a base; a shaft extending from a surface of the base, the shaft defining an axis of rotation and having a waveguide core; a rotating component mounted to the shaft and rotatable about the axis of rotation, the rotating component including one or more sensors; a first radio-frequency (RF) transceiver unit disposed in the rotating component, the first RF transceiver unit including a first antenna positioned at a first end of the shaft and oriented to transmit into the waveguide core of the shaft; and a second RF transceiver unit disposed in the base, the second RF transceiver unit including a second antenna at a second end of the shaft and oriented to receive RF signals through the waveguide core of the shaft. The waveguide core of the shaft provides a waveguide for bidirectional RF data transmissions between the first RF transceiver unit and the second RF transceiver unit.

In various embodiments, one of the components, e.g., the rotating component, can include a sensor array, such as a lidar sensor array or any other sensor array that produces data. The component can also include a sensor controller coupled to the sensor array. The sensor controller can be configured to provide some or all of the data produced by the sensor array to the RF transmitter (or transceiver) unit of the rotating component. In some embodiments, the sensor controller can also receive configuration data for the sensor array via the uplink (which can be, e.g., an RF uplink or an optical uplink).

The following detailed description, together with the accompanying drawings, will provide a better understanding of the nature and advantages of the claimed invention.

### BRIEF DESCRIPTION OF THE DRAWINGS

FIG. 1 shows a 360-degree lidar system in the context of an automotive application, according to some embodiments.

FIG. 2A shows a simplified perspective-view of a spinning lidar system according to some embodiments.

FIG. 2B shows a top view of the spinning lidar system of FIG. 2A.

FIG. 3 shows a simplified cross section view of a spinning lidar system that incorporates an RF data link according to some embodiments.

FIG. 4 shows a simplified cross-section view of components of an RF data link according to some embodiments.

FIGS. 5A and SB show simplified top views of a transmit antenna and a receive antenna, respectively, according to some embodiments.

FIG. 6 is a simplified cross-section view showing additional details of an RF receiver unit according to some embodiments.

FIG. 7 shows a simplified cross-section view of a bidirectional data link according to some embodiments.

### DETAILED DESCRIPTION

The following description of exemplary embodiments of the invention is presented for the purpose of illustration and description. It is not intended to be exhaustive or to limit the claimed invention to the precise form described, and persons skilled in the art will appreciate that many modifications and variations are possible. The embodiments have been chosen and described in order to best explain the principles of the invention and its practical applications to thereby enable others skilled in the art to best make and use the invention in various embodiments and with various modifications as are suited to the particular use contemplated.

### 1. Lidar System Overview

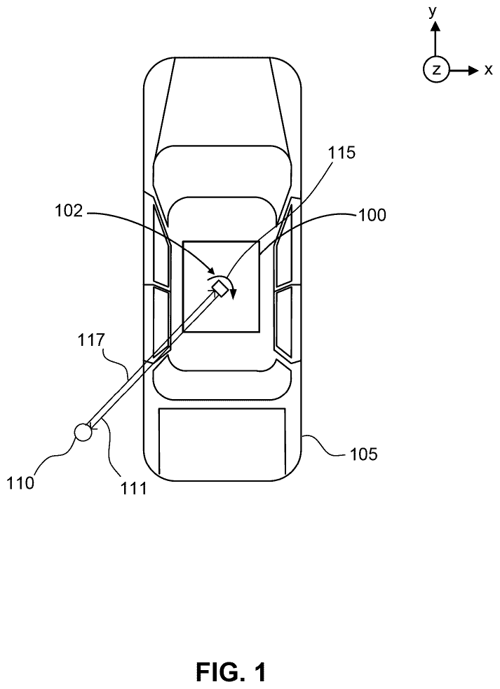

FIG. 1 shows a 360-degree lidar system 100 in the context of an automotive application, according to some embodiments. The automotive application for the lidar system is chosen here merely for the sake of illustration, and sensors and devices of the kind described herein may be employed in other types of vehicles, e.g., boats, aircraft, trains, etc., as well as in a variety of other applications where rotating sensors are useful, such as medical imaging, geodesy, geomatics, archaeology, geography, geology, geomorphology, seismology, forestry, atmospheric physics, laser guidance, airborne laser swath mapping (ALSM), and laser altimetry. According to some embodiments, lidar system 100 can be mounted on the roof of a vehicle 105 as shown in FIG. 1.

In some embodiments, lidar system 100 includes a spinning lidar system 102 that can employ a rotating architecture, where the pointing direction (i.e., angular position) of lidar system 102 can be scanned across all or a portion of a 360 degree field of view around the vehicle 105. In some embodiments, pulsed output beam(s) 111 from one or more emitters in lidar system 102 can be emitted into the surrounding environment, as shown. Objects in the path of beam(s) 111 can reflect portions 117 of light 111, and these reflected portions 117 can travel back to spinning lidar system 102 and can be detected by photodetectors in spinning lidar system 102. Based on a time difference between the emission and detection, computations can determine the distance of an object from the lidar system (also referred to herein as “range”) at a point 110 in the environment surrounding the vehicle. While only a single point 110 is shown in FIG. 1 at the given angular direction, spinning lidar system 102 may include an array of emitters (e.g., distributed up and down the z-axis) and a corresponding array of photodetectors for measuring depth values at a corresponding array of points for any given orientation of the output beam(s) 111. Two dimensional (2D) arrays of emitters and photodetectors can also be used.

Spinning lidar system 102 can be mechanically rotated about the z-axis (as indicated by clockwise rotation direction 115) to capture a lidar image of a full field of view that is 360 degrees around the vehicle 105. In some embodiments, the rotation can be implemented by mechanical means, e.g., by mounting spinning lidar system 102 to a rotating column or platform that can be driven by an electric motor. In other embodiments, the rotation can be implemented through other mechanical means such as through the use of galvanometers. In these and other embodiments, the field of view can be further expanded (e.g., along the z axis) using chip-based steering components and techniques; examples include using microchips that employ one or more MEMS based reflectors such as a digital micromirror (DMD) device, a digital light processing (DLP) device, or the like. In some embodiments, scanning can be effectuated in part through non-mechanical means, e.g., by using electronic signals to steer one or more optical phased arrays. A combination of scanning techniques can be implemented. For purposes of the present disclosure, it is assumed that the sensors are mounted on a component that mechanically rotates, or spins, about an axis (referred to generally as the z axis).

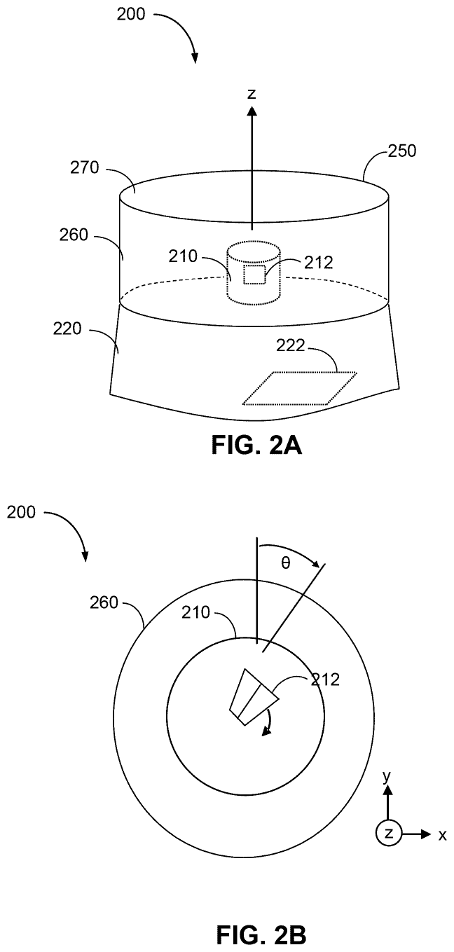

FIG. 2A shows a simplified perspective-view of a spinning lidar system 200 according to certain embodiments. Spinning lidar system 200 can be used, e.g., to implement spinning lidar system 102 shown in FIG. 1. Spinning lidar system 200 can include a rotating component 210 and a stationary component, also referred to as a “base,” 220. Rotating component 210 can include a sensor array 212 as well as a microcontroller and other supporting components. In some embodiments, sensor array 212 can include one or more emitters (e.g., vertical cavity semiconductor lasers (VCSELs), edge emitting lasers, or the like) and corresponding photodetectors (e.g., avalanche photodiodes (APDs), single photon avalanche diodes (SPADs), or other photodetectors usable for ranging measurements of the kind describe above with reference to FIG. 1). Any implementation of lidar sensors and/or any other sensors can be provided.

Rotating component 210 can be rotatably mounted to base 220. Base 220 is referred to herein as “stationary” to indicate that it provides a reference frame for the rotation of rotating component 220; however, it should be understood that base 220 need not be stationary with respect to an environment in which system 200 operates. For instance, base 220 can be mounted on a vehicle. Base 220 can include a system controller 222, a motor to drive rotating component 210 (not shown in FIG. 2A), and other components. Base 220 can also include mechanical features such as mounting fixtures or the like.

In some embodiments, a housing 250 can extend from base 220 to enclose rotating component 210. Housing 250 can include an optically transparent window 260 (which can extend up to 360 degrees around the sides of scanning lidar system 200) and a lid 270. Housing 250 can protect sensor array 212 and other components from the elements, as well as providing a stationary external surface and/or esthetic benefits.

FIG. 2B shows a simplified top view of spinning lidar system 200, as would be seen looking down along the z-axis at lidar system 200 with lid 270 removed. At any given point in time, rotating component 210 can be pointing in a specific angular direction θ (which can be measured relative to a fixed reference direction, such as along the y-axis as shown), and sensor array 212 can be operated to generate distance and intensity values for objects in the field in that specific direction. As rotating component 210 rotates (e.g., spins) about the z-axis, distance and intensity values can be measured for multiple directions, e.g., as defined by the time/rate for performing a measurement. Thus, spinning lidar system 200 can provide a 360-degree panoramic view of the volume surrounding it.

In some embodiments, rotating component 210 can rotate, e.g., at a speed of 10-50 revolutions per second, and depth images for the 360-degree field of view can be captured at a corresponding frame rate. Depending on factors such as the number of sensors and the frame rate, sensor array 212 can be capable of generating data at high rates (e.g., several gigabits per second). To make the sensor data available outside of lidar system 200 in real time, it is desirable to communicate the data from sensor array 212 to system controller 222 while sensor array 212 is rotating.

### 2. RF Data Link

According to some embodiments of the present invention, a spinning lidar system such as lidar system 200 can include a radio-frequency (RF) data link to support data transfer from sensor array 212 (or other devices in rotating component 210) to stationary base 220. In some embodiments, the RF data link can operate at a carrier frequency in the millimeter wave band. As used herein, the “millimeter wave band” includes wavelengths from about 1 mm to about 10 mm, corresponding to frequencies in air of about 30 to 300 GHz. In some embodiments, the carrier frequency can be between 50 and 65 GHz and can be approximately 60 GHz, e.g., 60.5 GHz in some implementations. Other wavelengths, including wavelengths outside the millimeter wave band, can also be used, if desired. A central shaft that supports rotation of rotating component 210 about the z-axis can provide a waveguide for efficient RF signal transmission between a first antenna located in or on rotating component 210 and a second antenna located in or on base 220.

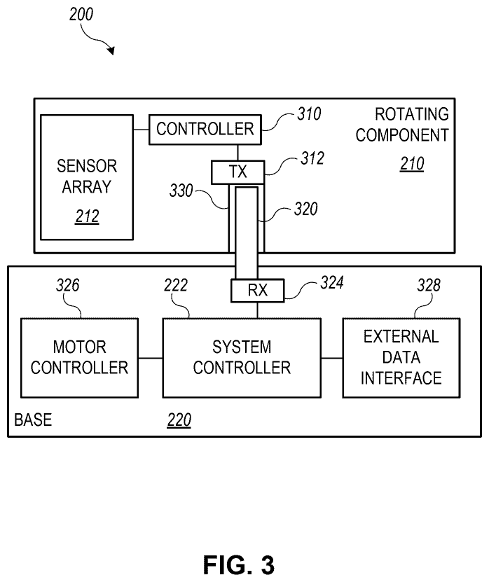

FIG. 3 is a simplified cross section view of spinning lidar system 200 that incorporates an RF data link according to some embodiments. Rotating component 210 and (stationary) base 220 can be coupled by a shaft 320 that extends outward from base 220. Shaft 320 can be, e.g., a hollow cylindrical structure that is fixedly attached at one end to base 220. A housing of rotating component 210 can include a cavity defined by a sidewall 330, into which shaft 320 is inserted. Friction-reducing mechanisms, such as bearings, fluids, or the like, can be introduced between sidewall 330 and shaft 320 to allow low-friction rotation of rotating component 210 about shaft 320.

Rotating component 210 can include sensor array 212, a sensor controller 310, and an RF transmitter (TX) unit 312. Sensor array 212 can be a lidar sensor array as described above, and can be implemented using one or more integrated circuits and/or discrete components. Any number and combination of sensors can be included, and sensor array 212 can include light emitters or other components that generate a stimulus in the environment in addition to detectors. Data communication as described herein is independent of the details of sensor operation or data generation, and sensor array 212 can include one or more of any type of sensor and/or combination of different types of sensors. Sensor controller 310 can include a microprocessor, microcontroller, ASIC, FPGA, or the like. In operation, sensor controller 310 can enable and disable sensor array 212, control operation of individual emitters and/or sensors, and receive data from sensor array 212. In some embodiments, sensor controller 310 can perform processing operations on data received from sensor array 212. Sensor controller 310 can also prepare the data for transmission to stationary base 220. For instance, sensor controller 310 can generate data structures that associate particular data values with particular sensors within sensor array 212 and/or particular time stamps; additionally or instead, sensor controller 310 can generate data packets that contain the data. If desired, data packets generated by sensor controller 310 can incorporate error detection codes and/or forward error correction codes. Regardless of any particular structure or format of the data, controller 310 can provide a data stream to RF transmitter unit 312.

RF transmitter unit 312 can include RF transmitter circuitry and an antenna. The RF transmitter circuitry can generate an RF carrier signal (e.g., at a frequency of around 60 GHz or other millimeter-wave frequency), generate an analog data signal from a digital data stream provided by sensor controller 310, and modulate the analog data signal onto the carrier signal (e.g., using amplitude shift keying, phase shift keying, or a combination thereof), thereby generating a driving signal for the antenna. The antenna can be configured to direct the RF signal toward base 220. Example implementations of RF transmitter unit 312 are described below.

Base 220 can include system controller 222, motor controller 326, RF receiver (RX) unit 324, and external data interface 328. Motor controller 326 can include electrical and/or mechanical elements to operate a motor (not shown) to effect rotation of rotating component 210 about shaft 320. Data communication as described herein is independent of the details of motor operation, and any type of motor and control mechanisms to produce rotation of rotating component 210 can be used. External data interface 328 can include components implementing wired and/or wireless data communication protocols that enable communication with systems external to system 200. For example, external data interface 328 can include a USB port, USB-C port, other wired communication port, and/or transceivers for wireless communication (e.g., implementing Bluetooth or Wi-Fi standards). External data interface 328 can be a bidirectional communication interface that supports transmitting data from lidar system 200 (including sensor data obtained from sensor array 212 via the RF data link) to an external system and receiving configuration and control signals from an external system.

RF receiver unit 324 can include an antenna and RF receiver circuitry. The antenna can be sensitive to RF signals generated by RF transmitter unit 312. The RF receiver circuitry can demodulate received RF signals and perform baseband processing to recover a digital data stream, which can be delivered to system controller 222. Example implementations of RF receiver unit 324 are described below.

System controller 222 can include a microprocessor, microcontroller, ASIC, FPGA, or the like. In operation, system controller 222 can serve as a main controller for spinning lidar system 200. For example, system controller 222 can receive control signals via external data interface 328 and generate control signals for other system components, such as motor controller 326 and/or sensor array 212. System controller 222 can also receive sensor data from RF receiver unit 324 and output some or all of the data via external data interface 328. In some embodiments, system controller 222 can perform processing operations on the received data and can output any combination of received data and/or results of processing operations.

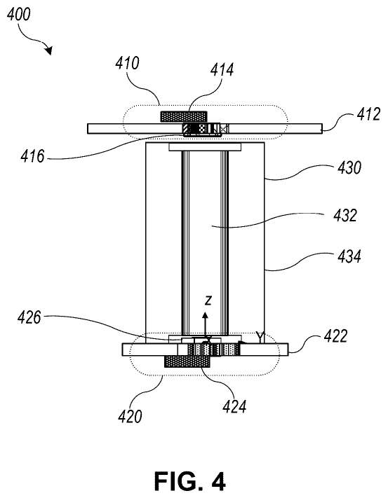

FIG. 4 shows a simplified cross-section view of components of an RF data link 400 according to some embodiments. RF data link 400 can be implemented in spinning lidar system 200 or other systems having a stationary base and a rotating (e.g., spinning) component. For ease of description, it is assumed that RF data link 400 is used to transmit data from a rotating component (e.g., rotating component 210 described above) to a stationary component (e.g., base 220 described above); this direction can be referred to as a “downlink” direction.

RF data link 400 includes a transmitter unit 410 (e.g., implementing RF transmitter unit 312) and a receiver unit 420 (e.g., implementing RF receiver unit 324) positioned at opposite ends of a shaft 430 (e.g., implementing shaft 320), the center of which defines an axis of rotation (referred to herein as the “z axis”). Receiver unit 424 can be fixedly coupled to shaft 430, while transmitter unit 410 is rotatable about the z axis.

Shaft 430 can be a structure of generally cylindrical shape having a waveguide core 432. In some embodiments, waveguide core 432 can be a hollow core defined by the inner surface of sidewall 434 of shaft 430. The region inside waveguide core 432 can be filled with air or any other RF-transparent medium. In other implementations, a separate waveguide structure can be inserted into or fabricated within shaft 430. A variety of waveguide structures can be used, provided that the waveguide structure can propagate RF electromagnetic radiation having frequencies associated with RF data link 400 from one end to the other. As described below, waveguide core 432 can act as a waveguide for RF signals propagating between transmitter unit 410 and receiver unit 420. In some embodiments, waveguide core 432 can have a cylindrical shape that can reduce the angular dependence of RF signal coupling efficiency; however, other shapes are not precluded. The outer surface of sidewall 434 of shaft 430 can be smooth and cylindrical or can incorporate various surface features that may be desired, e.g., for mechanical coupling between the rotational and stationary components; examples include channels for bearings, retention features to restrict movement of the rotating component along the z-axis, and so on.

Transmitter unit 410 can include a printed circuit board (PCB) 412 having a transmit antenna 416 mounted on the side proximate to shaft 430 and a transmitter chip 414 mounted on the opposite side. Vias through PCB 412 (not shown in FIG. 4) can provide electrical connections between transmitter chip 414 and transmit antenna 416. Similarly, receiver unit 420 can include a PCB 422 having a receive antenna 426 mounted on the side proximate to shaft 430 and a receiver chip 424 mounted on the opposite side. Vias (not shown in FIG. 4) can provide electrical connections between receiver chip 424 and receive antenna 426. In some embodiments, transmitter chip 414 and receiver chip 424 can be off-the-shelf components, tuned to the same carrier frequency. For instance, ST60 RF transmitter and receiver chips currently available from STMicroelectronics can be used. Other transmitters and receivers can also be used.

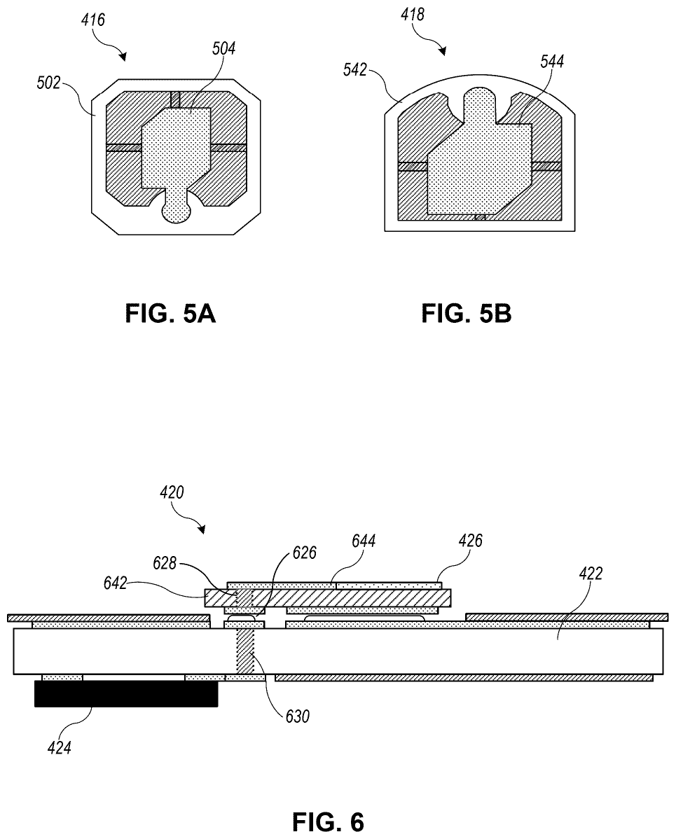

In some embodiments, antennas 416 and 426 can be planar patch antennas tuned to the carrier frequency of transmitter chip 414 and receiver chip 424. FIGS. 5A and 5B show simplified top views of antenna 416 and antenna 418, respectively, according to some embodiments. Antennas 416, 418 can be fabricated using a dielectric substrate 502, 542 that has a stable dielectric constant (including, e.g., low variation with temperature). In some embodiments, the substrate can be a low-loss copper-clad laminate (CCL) such as RO4350B CCL available from Rogers Corp. Copper or other conductive material can be used to print the desired antenna shapes 504, 544 onto one surface of respective substrates 5042 542. Antenna shapes 504, 544 may be symmetrical or asymmetrical as desire. In various embodiments, asymmetrical antenna shapes can provide more uniform performance across a range of rotational speeds, while symmetrical shapes may provide optimal performance at a specific rotational speed. Electrical contact pads can be formed on the reverse side (not shown in FIGS. 5A and 5B) of substrates 502, 542 and connected to antenna shapes 504, 544 by vias through respective substrates 502, 542. In some embodiments, contact pads can be implemented as a land grid array (LGA) or using other surface-mount techniques.

FIG. 6 is a simplified cross-section view showing additional details of receiver unit 420 according to some embodiments. PCB 422 can be a multilayer PCB of any size and shape desired. In some embodiments PCB 422 can provide a main logic board for base 220, and system controller 222 and other components can be mounted on PCB 422. Alternatively, PCB 422 can be a secondary logic board that holds RF receiver unit 420 (and optionally other components) and that has a connector or cable attachment or the like to couple electrically to the main logic board. Receiver chip 424 can be mounted on one side of PCB 422. For example, receiver chip 424 can be provided in a ball grid array (BGA) package that can be soldered to PCB 422. Antenna 426 can be mounted to the opposite side of PCB 422, e.g., using solder 626. Antenna 426 can include, e.g., an antenna shape 644 printed on one side of a substrate 642. As shown, a via 628 can extend through substrate 642 of antenna 426, and a via 630 can extend through PCB 422, providing an electrical connection between antenna 426 and receiver chip 424. (While only one connection path is shown, it should be understood that there can be any number of connections.) As FIG. 6 suggests, assembly of receiver unit 420 can be accomplished using conventional pick-and-place and soldering technologies. Transmitter unit 410 can be similarly constructed.

Referring again to FIG. 4, transmitter unit 410 and receiver unit 420 can be arranged such that antennas 416 and 426 are oriented toward shaft 430. In particular, antennas 416 and 426 can be disposed within the openings of waveguide core 432 at opposite ends of shaft 430. Accordingly, waveguide core 432 can act as a waveguide for RF signals propagating through waveguide core 432 from transmit antenna 416 to receive antenna 426. The sidewall of waveguide core 432 can be made of or coated with an RF-reflective material. For instance, shaft 430 can be made of aluminum and optionally coated with organic solderability preservative (OSP) or the like. In some embodiments, RF absorber material can be selectively placed at the ends of the waveguide to reduce cavity resonance and maintain high bandwidth without obstructing antennas 416, 426.

In this example, transmitter unit 410, including transmit antenna 416, is incorporated into a rotating component (e.g., rotating component 210 described above) and is assumed to operate while rotating relative to receive antenna 426. To reduce fluctuations in signal strength as the rotation angle changes, transmit antenna 416 can be optimized to produce circularly polarized RF waves while receive antenna 426 is optimized for coupling to the waveguide (i.e., waveguide core 430).

The sizes and shapes of antennas 416 and 426 and the length and diameter of waveguide core 432 (also referred to as the inner diameter of shaft 430) can be optimized to maximize signal strength, subject to other design constraints such as overall form factor, desired range of rotation speeds, and so on. For instance, the diameter of waveguide core 432 can be optimized to reduce propagation of unwanted modes. The thicknesses and shapes of the dielectric substrates 502, 542 of antennas 416 and 426 and the shapes of antenna structures 504, 544 can also be optimized. The thicknesses of the two substrates need not be equal. For instance, transmit antenna substrate 504 can have a thickness of 10 mil while receive antenna substrate 544 has a thickness of 20 mil. Shaft 430 should be long enough to avoid significant near-field effects (e.g., at least one to two times the RF carrier wavelength, or about 5-10 mm for a 60 GHz carrier frequency). At the other extreme, shaft 430 can be as long as desired, although the decrease of signal strength with increasing length of the transmission path may impose an upper limit, given a particular combination of transmitter strength and receiver sensitivity. In some embodiments, coatings for the inner surface of shaft 430 can be selected to reduce signal loss. The inner diameter of shaft 430 can be optimized to reduce propagation of unwanted modes. In one example, the inner diameter is 3.56 mm. More generally, optimization of antenna shapes and antenna and waveguide dimensions for a particular carrier frequency and shaft length can be achieved using RF simulation software. The outer diameter of shaft 430 does not affect the RF data link and can be selected according to design considerations unrelated to RF performance. Providing a circular cross-section for waveguide core 432 can enable rotational symmetry, reducing the effect of rotation angle on signal strength; however, use of other shapes is not precluded.

In some embodiments, RF data link 400 can support high data rates—e.g., around 4 Gbps in some implementations using a 60 GHz carrier frequency—in a compact form factor and with low manufacturing cost. “Design and forget” implementations are possible, in which, as long as all parts are within manufacturing tolerances, any further individual tuning of assembled systems can be omitted. Depending on the particular components used, RF data link 400 can operate across a wide range of temperatures, e.g., from −40° C. to 105° C. In some embodiments, shaft 430 can provide sufficient electromagnetic shielding to prevent signals on RF data link 400 from interfering with operation of other components of the system in which RF data link 400 is implemented. Such shielding can also prevent electromagnetic interference (EMI) between the system in which RF data link 400 is implemented and other systems and can also prevent eavesdroppers from intercepting transmissions on RF data link 400. It is noted that GHz electromagnetic waves generally do not propagate significant distances in air (due in large part to absorption of photons by water molecules in the air), and this can reduce the amount of shielding material needed to achieve compliance with EMI regulations that may be applicable.

In some embodiments, RF data link 400 can be implemented as a bidirectional link. For instance, antennas 416, 426 can be operated as bidirectional antennas that are operable in transmit or receive mode, and transmitter and receiver chips 414, 424 can be augmented with complementary chips or replaced with bidirectional transceiver chips. Various protocols can be used to time-multiplex uplink and downlink transmissions. As noted above, in some embodiments antennas 416, 426 can be optimized differently, with antenna 416 optimized for transmission and antenna 426 optimized for reception, thereby supporting a high-bandwidth downlink with data rates that can exceed 1 Gbps. Such optimization does not preclude using the same antennas 416, 426 with transmitter and receiver roles reversed to provide an uplink signal path. The resulting uplink may have a lower bandwidth than the downlink, provided that the bandwidth is sufficient to transmit the uplink data in a particular application. Alternatively, a separate transmit and receive antenna can be provided at each end of waveguide core 432. As compared to single-antenna arrangements, a dual-antenna arrangement may entail a wider waveguide core 432 to allow both pairs of antennas to transmit into the same waveguide.

3. RF Downlink with Optical Uplink

For some applications, the uplink and downlink direction can have different data throughput requirements. In examples herein, it is assumed that the downlink direction carries more data at higher rates; the uplink may carry smaller amounts of data, and a lower data rate may be sufficient. For instance, in spinning lidar system 200 of FIG. 2, the downlink carries large volumes of sensor data while the uplink carries configuration data (e.g., a few hundred bytes to a few kilobytes). Accordingly, some embodiments combine an RF downlink with a lower-bandwidth uplink optical coupling.

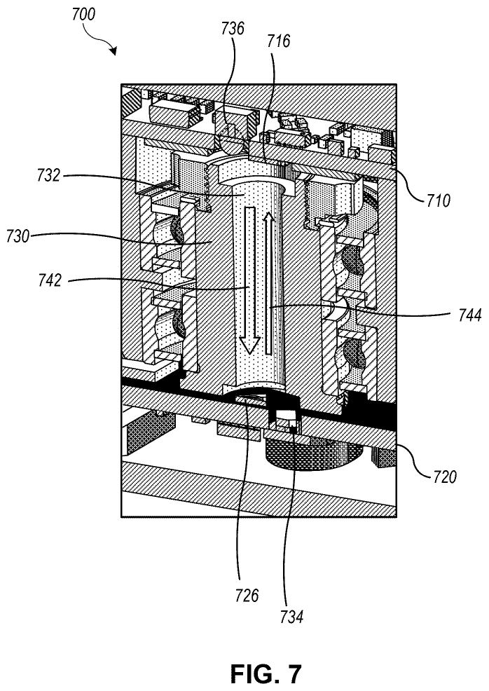

FIG. 7 shows a simplified cross-section view of a combination RF/optical data link 700 according to some embodiments. Data link 700 includes an RF downlink (indicated by arrow 742) and an optical uplink (indicated by arrow 744), with downlink and uplink signals both propagating through a waveguide core 732 of a shaft 730. At the rotating (or upstream) end, a PCB 710 can have mounted thereon an RF transmitter unit that includes an RF antenna 716, along with a separate optical receiver unit that includes an optical detector 736. RF transmit antenna 716 can be similar or identical to transmit antenna 416 or other transmit antennas described above. Optical detector 736 can include any detector capable of detecting an optical signal, such as light pulses having a particular wavelength. At the stationary (or downstream) end, PCB 720 can have mounted thereon an RF receiver unit that includes an RF antenna 726, along with a separate optical transmitter unit that includes a light emitter 734. RF receive antenna 726 can be similar or identical to receive antenna 426 or other receive antennas described above. Light emitter 734 can include a light-emitting diode (LED) or other compact light source that can be modulated (e.g., pulsed) by a control circuit (not shown) to communicate information. A variety of optical emitters and detectors, including components of conventional design, can be used. In some embodiments, uplink bandwidth may be on the order of megabits per second while downlink bandwidth is on the order of hundreds of megabits to gigabits per second. In addition to acting as a waveguide for RF waves, waveguide core 732 of shaft 730 can also provide a line-of-sight transmission path between light emitter 734 and optical detector 736. In some embodiments, antennas 724 and 726 can be offset from the center of shaft 730 to provide space for light emitter 734 and optical detector 736.

As FIG. 7 illustrates, an uplink and downlink can be implemented using different technologies, with one direction (e.g., the downlink) using RF communication as described herein to support high bandwidth while the other direction (e.g., the uplink) uses a lower-bandwidth option such as optical communication. Other combinations are also possible, including bidirectional RF links using either bidirectional antennas or two pairs of dedicated antennas.

### 4. Additional Embodiments

While the invention has been described with reference to specific embodiments, it will be appreciated that variations and modifications are possible. The terms “rotating” and “stationary” are used to distinguish the two components, in that the rotating component rotates relative to the stationary component. A stationary component can be mounted on a moving vehicle or other moving platform and need not be stationary with respect to Earth or any other object in the environment. While embodiments described herein assume that the primary data source is included in a rotating component and the downlink goes from the rotating component to a stationary component, the reverse is not precluded.

The terms “downlink” and “uplink” are used herein to distinguish the two directions of communication in a point-to-point data link. In examples herein, “downlink” refers to the direction of data transmission from a sensor array toward another system component, while “uplink” refers to the reverse direction. However, such labels are arbitrary, and it should be understood that RF data links of the kind described herein can be implemented for either direction or for both directions: for the downlink only; for the uplink only; or for both the downlink and the uplink. Where an RF data link is implemented for only the downlink (or only the uplink), another type of data link (including an optical data link as described above) can be implemented for the reverse direction. RF data links of the kind described herein can also be implemented in embodiments where a unidirectional data link is desired.

In addition, while the waveguide core is described as being in a shaft that is fixedly mounted to the stationary base, some alternative implementations can have the shaft fixedly mounted to the rotating component, or the shaft can be rotatable with respect to both components. Further, while the foregoing description makes reference to a “spinning” system, in which the rotating component can continuously rotate in the same direction through at least 360 degrees, other rotational movements are not precluded; for instance a rotational component can oscillate back and forth through an angle of 360 degrees or less.

In addition, a lidar sensor array is used as an example of a rotating sensor array that can benefit from an RF data link as described herein. Those skilled in the art with the benefit of this disclosure will understand that RF data links of the kind described herein can be used with any system that includes a rotating sensor array or more generally in any system where a component that includes a data source produces data while rotating relative to a component that includes a data receiver.

While various circuits and components are described herein with reference to particular blocks, it is to be understood that these blocks are defined for convenience of description and are not intended to imply a particular physical arrangement of component parts. The blocks need not correspond to physically distinct components, and the same physical components can be used to implement aspects of multiple blocks. Components described as dedicated or fixed-function circuits can be configured to perform operations by providing a suitable arrangement of circuit components (e.g., logic gates, registers, switches, etc.); automated design tools can be used to generate appropriate arrangements of circuit components implementing operations described herein. Components described as processors or microprocessors can be configured to perform operations described herein by providing suitable program code. Various blocks might or might not be reconfigurable depending on how the initial configuration is obtained. Embodiments of the present invention can be realized in a variety of apparatus including electronic devices implemented using a combination of circuitry and software.

All processes described herein are also illustrative and can be modified. Operations can be performed in a different order from that described, to the extent that logic permits; operations described above may be omitted or combined; and operations not expressly described above may be added.

A recitation of “a”, “an” or “the” is intended to mean “one or more” unless specifically indicated to the contrary. Reference to “one” of a particular component, feature, or other element is not intended to preclude additional co-existing instances of that component, feature, or other element, unless specifically indicated to the contrary. The use of “or” is intended to mean an “inclusive or,” and not an “exclusive or” unless specifically indicated to the contrary.

Accordingly, although the invention has been described with respect to specific embodiments, it will be appreciated that the invention is intended to cover all modifications and equivalents within the scope of the following claims.

What is claimed is:

1. A system comprising:
a first component;
a shaft extending from a surface of the first component, the shaft defining an axis of rotation and having a waveguide core;
a second component mounted to the shaft and rotatable about the axis of rotation;
a radio-frequency (RF) transmitter unit disposed in the second component, the RF transmitter unit including a first antenna positioned at a first end of the shaft and oriented to transmit RF signals into the waveguide core of the shaft; and
an RF receiver unit disposed in the first component, the RF receiver unit including a second antenna positioned at a second end of the shaft and oriented to receive the RF signals through the waveguide core of the shaft,
wherein the waveguide core of the shaft provides a waveguide for RE data transmissions between the first antenna and the second antenna.

2. The system of claim 1 wherein the RF data transmissions are in a millimeter-wave band.

3. The system of claim 1 wherein the first antenna is configured to produce circularly polarized RF waves.

4. The system of claim 1 wherein the waveguide core comprises a hollow core of the shaft.

5. The system of claim 1 wherein the second component includes one or more sensors to generate data.

6. The system of claim 1 wherein each of the first antenna and the second antenna is a patch antenna having:
a substrate comprising a low-loss copper clad laminate; and
a metallic antenna shape printed on a surface of the substrate.

7. The system of claim 6 wherein the substrate of the first antenna has a first thickness and the substrate of the second antenna has a second thickness different from the first thickness.

8. The system of claim 1 wherein:
the RF transmitter unit includes an RF transmitter chip mounted on a first side of a first printed circuit board;
the first antenna is a patch antenna mounted on a second side of the first printed circuit board opposite the first side of the first printed circuit board; and
the second side of the first printed circuit board is oriented toward the shaft.

9. The system of claim 8 wherein:
the RF receiver unit includes an RF receiver chip mounted on a first side of a second printed circuit board;
the second antenna is a patch antenna mounted on a second side of the second printed circuit board opposite the first side of the second printed circuit board; and
the second side of the second printed circuit board is oriented toward the shaft.

10. The system of claim 1 wherein the waveguide core of the shaft has a circular cross section and a diameter selected to reduce propagation of unwanted electromagnetic modes.

11. The system of claim 1 further comprising:
an optical transmitter unit mounted to the first component and optically coupled to the waveguide core of the shaft; and
an optical receiver unit mounted to the second component and optically coupled to the waveguide core of the shaft.

12. The system of claim 11 wherein the second component includes:
a sensor array; and
a sensor controller coupled to the sensor array,
wherein the sensor controller is configured to provide data from the sensor array to the RF transmitter unit and to receive configuration data for the sensor array from the optical receiver unit.

13. The system of claim 1 wherein the second end of the shaft is fixedly attached to the first component.

14. The system of claim 1 wherein the second component includes a lidar sensor array configured to produce data and wherein the RF transmitter unit is configured to transmit at least some of the data produced by the lidar sensor array.

15. A system comprising:
a base;
a shaft extending from a surface of the base, the shaft defining an axis of rotation and having a waveguide core;
a rotating component mounted to the shaft and rotatable about the axis of rotation, the rotating component including one or more sensors;
a first radio-frequency (RF) transceiver unit disposed in the rotating component, the first RF transceiver unit including a first antenna positioned at a first end of the shaft and oriented to transmit RF signals into the waveguide core of the shaft; and
a second RF transceiver unit disposed in the base, the second RF transceiver unit including a second antenna at a second end of the shaft and oriented to receive RF signals through the waveguide core of the shaft,
wherein the waveguide core of the shaft provides a waveguide for bidirectional RF data transmissions between the first RF transceiver unit and the second RF transceiver unit.

16. The system of claim 15 wherein the RF data transmissions are in a millimeter-wave band.

17. The system of claim 15 wherein the waveguide core comprises a hollow core of the shaft.

18. The system of claim 15 wherein the first antenna is configured to produce circularly polarized RF waves.

19. The system of claim 18 wherein the second RF transceiver unit further includes a third antenna positioned at the second end of the shaft and oriented to transmit into the waveguide core of the shaft, wherein the third antenna is configured to produce circularly polarized RF waves.

20. The system of claim 15 wherein each of the first antenna and the second antenna is a patch antenna having:
a substrate comprising a low-loss copper clad laminate; and
a metallic antenna shape printed on a surface of the substrate.

21. The system of claim 15 wherein the waveguide core of the shaft has a circular cross section and a diameter selected to reduce propagation of unwanted electromagnetic modes.

22. The system of claim 15 further comprising:
a lidar sensor array disposed in the rotating component; and
a sensor controller coupled to the lidar sensor array,
wherein the sensor controller is configured to provide data from the lidar sensor array to the first RF transceiver unit and to receive configuration data for the lidar sensor array from the first RF transceiver unit.

23. The system of claim 22 wherein the second RF transceiver unit is configured to transmit configuration data for the lidar sensor array.
